(19) United States
(12) Patent Application Publication
(10) Pub. No.: US 2024/0255900 A1
(43) Pub. Date: Aug. 1, 2024

(54) METHODS AND SYSTEMS FOR ONE SCAN COOK

(71) Applicant: IPin Hsiao, San Mateo, CA (US)

(72) Inventor: IPin Hsiao, San Mateo, CA (US)

(21) Appl. No.: 18/508,223

(22) Filed: Nov. 13, 2023

Related U.S. Application Data
(60) Provisional application No. 63/424,733, filed on Nov. 11, 2022.

(51) Int. Cl. G05B 13/02

(52) U.S. Cl. CPC G05B 13/028

(57) ABSTRACT

Computer-implemented one scan cook methods, systems, and computer-readable media are described.

### RELATED APPLICATIONS

This application claims the benefit of U.S. Application No. 63/424,733, entitled “Methods and Systems for One Scan Cook,” filed on Nov. 11, 2022, which is incorporated herein by reference in its entirety.

### FIELD

Some implementations are generally related to appliance control systems, and, more particularly, to methods and systems for a one scan cook technique including an application configured to scan a food package or recipe, access a cooking database for cooking data, and program an appliance to cook the food based on the cooking data.

### BACKGROUND

People cooking at home often experience challenges in preparing food. Challenges can include reading and understanding instructions, which may be in small print and/or in units that may not be familiar to a user (e.g., metric vs. English units), variations in appliances (e.g., temperature setting accuracy, power levels, etc.), unfamiliarity with an appliance or cooking technique, or the like. Further problems can be caused by food preparation instructions providing ranges, such as a cooking time range of 10-15 minutes, where the time range coupled with the other issues above can lead to unsatisfactory results when preparing food. Some implementations of the disclosed subject matter have been conceived in light of the above-mentioned problems, among other things.

The background description provided herein is for the purpose of generally presenting the context of the disclosure. Work of the presently named inventor, to the extent it is described in this background section, as well as aspects of the description that may not otherwise qualify as prior art at the time of filing, are neither expressly nor impliedly admitted as prior art against the present disclosure.

### SUMMARY

Some implementations can include a computer-implemented method comprising receiving, at one or more processors, food product information and corresponding cooking information, and storing, using the one or more processors, the food product information and the corresponding cooking information in a data store. The method can also include receiving, at the one or more processors, food product information and appliance information from a user device, and retrieving, using the one or more processors, cooking information from the data store, wherein the cooking information corresponds to the food product information received from the user device. The method can further include transmitting, using the one or more processors, the cooking information to the user device.

In some implementations, the method can also include transmitting, from the user device, the cooking information to an appliance. In some implementations, the method can further include outputting, from the user device, the cooking information, wherein the outputting includes one or more of displaying the cooking information or providing the cooking information via audio output.

In some implementations, the method can further include receiving, at the one or more processors from the user device, one or more of review information or feedback information associated with one or more of a food product, the cooking information, and appliance data. In some implementations, the method can also include providing, from the one or more processors, the review or feedback information to an external system associated with a manufacturer of the food product.

In some implementations, the method can further include training, using the one or more processors, a model using the review or feedback information. In some implementations, the method can also include updating, using the one or more processors, cooking information in the data store based on output from the model trained using the review or feedback information.

In some implementations, one or more of the food product information or the appliance information from the user device is obtained at the user device via an image sensor on the user device. In some implementations, the user device is a mobile device. In some implementations, the user device is a kitchen appliance.

Some implementations can include a nontransitory computer readable medium having stored thereon software instructions that, when executed by one or more processors, causes the one or more processors to perform operations. The operations can include receiving, at the one or more processors, food product information and corresponding cooking information, and storing, using the one or more processors, the food product information and the corresponding cooking information in a data store. The operations can also include receiving, at the one or more processors, food product information and appliance information from a user device, and retrieving, using the one or more processors, cooking information from the data store, wherein the cooking information corresponds to the food product information received from the user device. The operations can further include transmitting, using the one or more processors, the cooking information to the user device.

In some implementations, the operations can also include transmitting, from the user device, the cooking information to an appliance. In some implementations, the operations can further include outputting, from the user device, the cooking information, wherein the outputting includes one or more of displaying the cooking information or providing the cooking information via audio output.

In some implementations, the operations can also include receiving, at the one or more processors from the user device, one or more of review information or feedback information associated with one or more of a food product, the cooking information, and appliance data. In some implementations, the operations can further include providing, from the one or more processors, the review or feedback information to an external system associated with a manufacturer of the food product.

In some implementations, the operations can also include training, using the one or more processors, a model using the review or feedback information. In some implementations, the operations can further include updating, using the one or more processors, cooking information in the data store based on output from the model trained using the review or feedback information.

In some implementations, one or more of the food product information or the appliance information from the user device is obtained at the user device via an image sensor on the user device. In some implementations, the user device is a mobile device. In some implementations, the user device is a kitchen appliance.

### BRIEF DESCRIPTION OF THE DRAWINGS

FIG. 1 is a block diagram of an example system and a network environment which may be used for one or more implementations described herein.

FIG. 2 is a flowchart of an example method of one scan cook in accordance with some implementations.

FIG. 3 is a diagram of an example one scan cook system in accordance with some implementations.

FIG. 4 is a block diagram of an example computing device which may be used for one or more implementations described herein.

FIG. 5 is a flowchart of an example method of one scan cook in accordance with some implementations.

FIG. 6 is a diagram of an example one scan cook system in accordance with some implementations.

FIG. 7 is a diagram of an example one scan cook system in accordance with some implementations.

### DETAILED DESCRIPTION

Some implementations include one scan cook methods and systems. As used herein, the phrase one scan cook refers to the disclosed process of scanning a food package or recipe with a mobile device or other device and setting an appliance to perform a cooking operation based on the scanning. Thus, a user can initiate cooking via one scan of a food package or recipe or other item indicating cooking instructions.

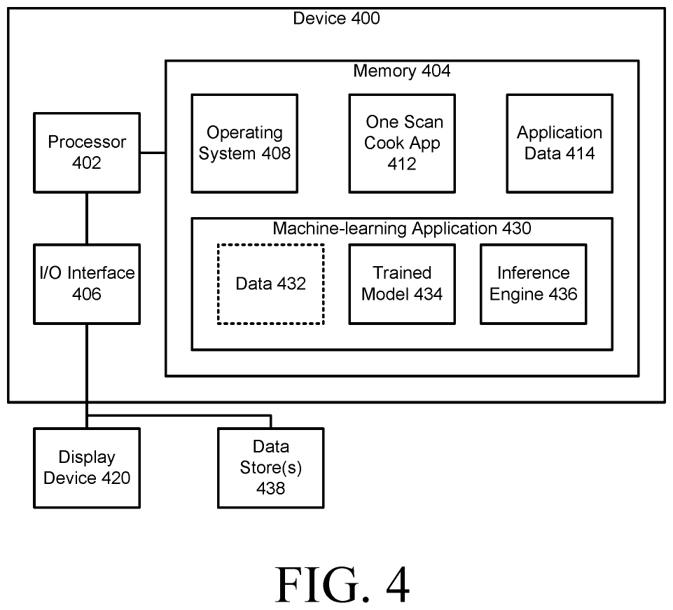

When performing one scan cook functions, it may be helpful for a system to suggest appliance settings or adjustments to food manufacturer cooking instructions and/or to make predictions about how cooking instructions may need to be adjusted. To make predictions or suggestions, a probabilistic model (or other model as described below in conjunction with FIG. 4) can be used to make an inference (or prediction) about aspects of one scan cook such as appliance settings (e.g., cooking mode, cooking temperature, cooking time, etc.). Accordingly, it may be helpful to make an inference regarding the probability that cooking instructions may be improved by adjusting base cooking instructions. A result of predicting adjustments to base cooking instructions can result in a cooking process that more often results in satisfactory results. Other aspects can be predicted or suggested as described below.

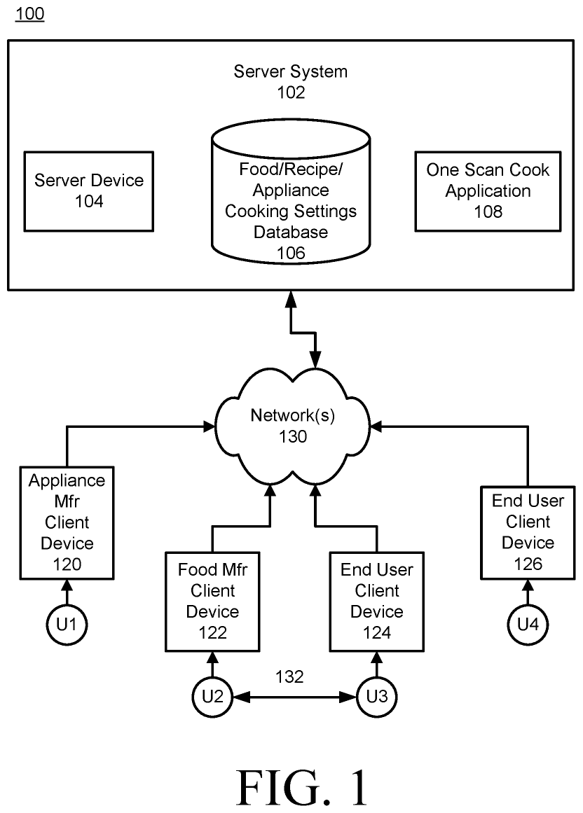

FIG. 1 illustrates a block diagram of an example network environment 100, which may be used in some implementations described herein. In some implementations, network environment 100 includes one or more server systems, e.g., server system 102 in the example of FIG. 1. Server system 102 can communicate with a network 130, for example. Server system 102 can include a server device 104, a database 106 or other data store or data storage device, and a one scan cook application 108. The network environment 100 also can include one or more client devices, e.g., client devices 120, 122, 124, and 126, which may communicate with each other and/or with server system 102 via network 130. Network 130 can be any type of communication network, including one or more of the Internet, local area networks (LAN), wireless networks, switch or hub connections, etc. In some implementations, network 130 can include peer-to-peer communication 132 between devices, e.g., using peer-to-peer wireless protocols.

For ease of illustration, FIG. 1 shows one block for server system 102, server device 104, database 106, and one scan cook application 108 and shows four blocks for client devices 120, 122, 124, and 126. Some blocks (e.g., 102, 104, and 106) may represent multiple systems, server devices, and network databases, and the blocks can be provided in different configurations than shown. For example, server system 102 can represent multiple server systems that can communicate with other server systems via the network 130. In some examples, database 106 and/or other storage devices can be provided in server system block(s) that are separate from server device 104 and can communicate with server device 104 and other server systems via network 130. Also, there may be any number of client devices. Each client device can be any type of electronic device, e.g., desktop computer, laptop computer, portable or mobile device, camera, cell phone, smart phone, tablet computer, television, TV set top box or entertainment device, wearable devices (e.g., display glasses or goggles, head-mounted display (HMD), wristwatch, headset, armband, jewelry, etc.), virtual reality (VR) and/or augmented reality (AR) enabled devices, personal digital assistant (PDA), media player, game device, etc. Some client devices may also have a local database similar to database 106 or other storage. In other implementations, network environment 100 may not have all of the components shown and/or may have other elements including other types of elements instead of, or in addition to, those described herein.

In various implementations, end-users U1, U2, U3, and U4 may communicate with server system 102 and/or each other using respective client devices 120, 122, 124, and 126. The client devices can include an appliance manufacturer client device 120, a food manufacturer client device 122 and one or more end user (e.g., consumer) client devices 124 and 126. In some examples, users U1, U2, U3, and U4 may interact with each other via applications running on respective client devices and/or server system 102, and/or via a network service, e.g., an image sharing service, a messaging service, a social network service or other type of network service, implemented on server system 102. For example, respective client devices 120, 122, 124, and 126 may communicate data to and from one or more server systems (e.g., server system 102). In some implementations, the server system 102 may provide appropriate data to the client devices such that each client device can receive communicated content or shared content uploaded to the server system 102 and/or network service. In some examples, the users can interact via audio or video conferencing, audio, video, text chat, or other communication modes or applications. In some examples, the network service can include any system allowing users to perform a variety of communications, form links and associations, upload and post shared content such as images, image compositions (e.g., albums that include one or more images, image collages, videos, etc.), audio data, and other types of content, receive various forms of data, and/or perform socially related functions. For example, the network service can allow a user to send messages to particular or multiple other users, form social links in the form of associations to other users within the network service, group other users in user lists, friends lists, or other user groups, post or send content including text, images, image compositions, audio sequences or recordings, or other types of content for access by designated sets of users of the network service, participate in live video, audio, and/or text videoconferences or chat with other users of the service, etc. In some implementations, a “user” can include one or more programs or virtual entities, as well as persons that interface with the system or network.

A user interface can enable display of images, image compositions, data, and other content as well as communications, privacy settings, notifications, and other data on client devices 120, 122, 124, and 126 (or alternatively on server system 102). Such an interface can be displayed using software on the client device, software on the server device, and/or a combination of client software and server software executing on server device 104, e.g., application software or client software in communication with server system 102. The user interface can be displayed by a display device of a client device or server device, e.g., a display screen, projector, etc. In some implementations, application programs running on a server system can communicate with a client device to receive user input at the client device and to output data such as visual data, audio data, etc. at the client device.

In some implementations, server system 102 and/or one or more client devices 120-126 can provide one or more one scan cook functions as described herein.

Various implementations of features described herein can use any type of system and/or service. Any type of electronic device can make use of the features described herein. Some implementations can provide one or more features described herein on client or server devices disconnected from or intermittently connected to computer networks.

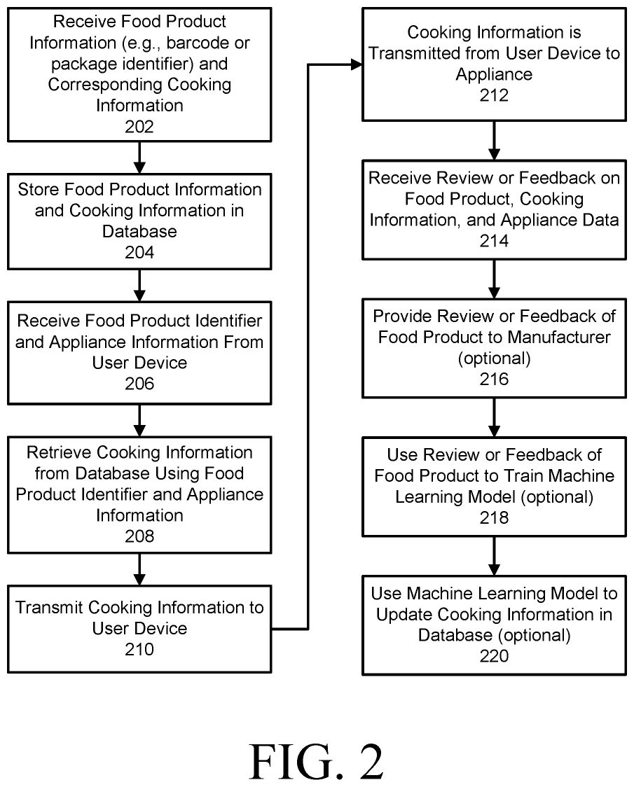

FIG. 2 is a flowchart of an example method of one scan cook in accordance with some implementations. Processing begins at 202, where food product information or recipe information is received. For example, a food product manufacturer can provide cooking data to the one cook system via a cooking data API. The cooking data can include data specific to an appliance and cooking method. For example, the cooking data can include data to cook the food product in one or more appliances such as a microwave, conventional oven, air fryer, sous vide cooking system, mixer, food processor, toaster oven, or another appliance. The cooking data can include appliance type, cooking mode, cooking power setting, cooking temperature, cooking time, initial delay time (e.g., delay before cooking), intermediate delay time (e.g., delay or pause during cooking), and final delay time (e.g., delay after cooking to permit food to rest). The food product information can include step-by-step cooking data, food product nutrition data, manufacturing date/expiration date decoding information, etc. The database can also store reviews, feedback, chat room data, and other data associated with the food product, appliance, or one scan cook app users.

The cooking data can also include a sequence of cooking data for more than one stage or phase of a cooking process. For example, cooking data for an oven could include a sequence of 15 mins at 300 F, then 10 mins at 500 F, cool down for 2 hrs, and then 30 mins 250 F. In another example, a blender cooking data sequence for Fresh Fruit Yogurt can include a sequence to add a yogurt bag and blend at low speed for 20 see then add a fruit bag and blend at high speed for 30 sec.

The cooking data can also include one or more sequences of cooking data for more than one stage or phase of a cooking process using multiple appliances or an appliance with multiple modes. For example, cooking sequences can include cross/multi-appliance operations during the same period of time. The phases on different appliances can overlap each other in the cooking data sequence and may be based on timing such that an appliance is ready to start a subsequent cooking phase when an earlier cooking phase ends (e.g., preheating an appliance to have it ready when an earlier phase ends on a different appliance). The overlapping can be used for other purposes as well such as starting two or more overlapping cooking phases such that multiple dishes are ready at approximately the same time. This feature can also be very useful when a user needs to prepare multiple dishes to save a lot of time from starting cooking until serving food on the table. For example, if we have 3 dishes that need to use the oven, a user can put the three dishes into the oven at same time then take each out according to its corresponding time within the corresponding phase of the cooking data sequence or sequences. In another example, for a dish such as orange chicken with vegetables: an example cooking data sequence can include frying pan set on high heat for 1 minute, adding an oil bag then a vegetable bag, heating on high for four minutes, adding orange chicken bag, cooking on extra high heat for 8 mins, adding seasoning herb bag, set heat to low and cook for 2 minutes. In yet another example, for a beef steak cooked to medium rare: an example cooking data sequence can include putting the vacuum sealed steak in a sous vide cooker set to cook at 50 C for 4 hours and then at 60 C for 30 minutes, using ae paper towel (included) to pat dry the steak, preheating a grill to 550 F starting at a time such that the grill will be preheated when the sous vide cooking phase is done and also preheating an oven to 220 F at a time such that the oven is preheated when the grilling phase is complete, grilling the steak at 550 F on the preheated grill for 50 seconds on a first side and then grilling for 50 seconds on the other side, top the steak with contents of a seasoning sauce bag, moving the steak to the preheated oven and cooking at 220 F for 10 minutes. In still another example, for cooking a ramen soup dish, the cooking data sequence can include setting a microwave to defrost and defrosting frozen soup for 2 minutes, adding a noodle bag to the defrosted soup, microwaving the noodles and defrosted soup for 150 secs, grilling pork at 500 F for 1 min per side at same time as the microwaving of the noodles and soup is being performed, then putting the grilled pork on top of the noodles and soup, and finally adding a seasoning herb mix to the soup. Processing continues to 204.

At 204, food product information and cooking data is stored in the one scan cook database (e.g., 106, 308, or 414). The cooking data can be used as provided by the manufacturer or updated or modified by a machine learning model or other technique to fine tune the cooking data to help ensure good results from the one scan cook technique. Processing continues to 206.

At 206, food product (or recipe) identifier information and appliance information is received from a user device. The food product/recipe information can include one or more of a machine-readable indicium (e.g., product barcode or QR code), package appearance image recognition, a barcode or QR code associated with a recipe, a recipe itself (e.g., via optical character recognition), food cooking instructions, or another suitable machine-readable indicium. Processing continues to 208.

At 208, cooking data corresponding to the food product or recipe identifier and appliance information is retrieved from the one cook database. For example, for a mozzarella cheese stick food product and an air fryer model from a given manufacturer provided by a user one scan cook app, the corresponding cooking data is retrieved to set the air fryer for cooking the mozzarella cheese sticks. Processing continues to 210.

At 210, the cooking data is transmitted to the user device. For example, the one scan cook system can transmit the cooking data to the user device via an API (e.g., 310). Processing continues to 212.

At 212, the cooking data is transmitted from the user device to the appliance (or appliances in the case of multiple appliance cooking data sequences). For example, the appliance can include a wired or wireless connection, such as a wireless module (e.g., a Wi-Fi or Bluetooth module) to permit the appliance to communicate with the user device. The appliance can send an acknowledgement to the user device to acknowledge receipt of the cooking data from the user device. The one scan cook application can also provide information to the user including step-by-step cooking instructions, food product manufacturing data or expiration date, nutrition information, etc. Processing continues to 214.

At 214, the one scan cook system can receive a review or feedback on the food product, which can include the cooking data and appliance data used for the cooking. The review/feedback of the food product can include text, audio, video, or an image. Processing continues to 216.

At 216, the review/feedback of the food product can optionally be provided to the food product manufacturer. Processing continues to 218.

At 218, the review/feedback can optionally be supplied to a machine learning system to help train or adapt a machine learning model. Processing continues to 220.

At 220, an output of the machine learning model can optionally be used to update cooking data in the one scan cook database. For example, if, based on one or more reviews or feedback data, the machine learning model outputs a recommendation to adjust the cooking instruction of a particular food product and appliance combination.

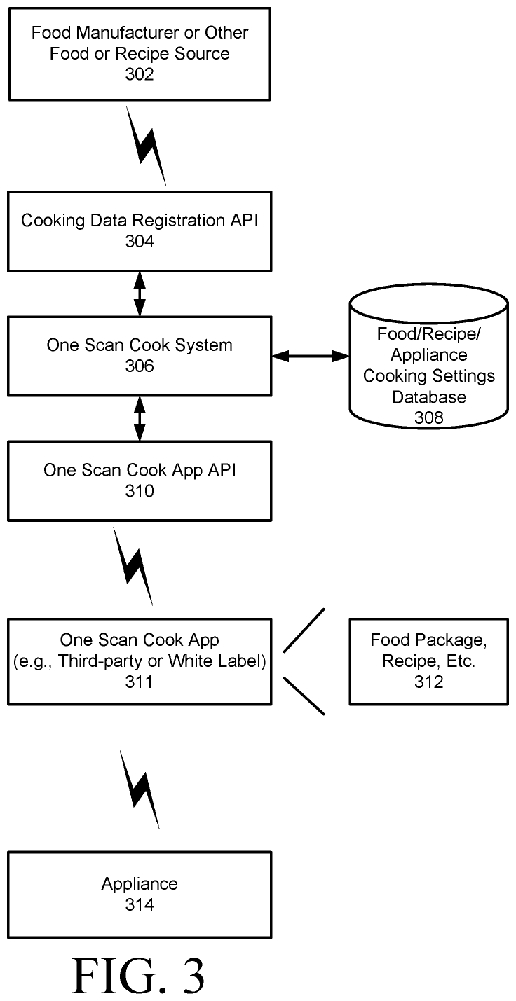

FIG. 3 is a diagram of an example one scan cook system in accordance with some implementations. FIG. 3 shows a food manufacturer or other food or recipe source 302 that can transmit food identification and/or cooking instructions via a cooking data application programming interface (API) 304 to a one scan cook system 306.

The one scan cook system 306 can store the cooking data received through the cooking data API (or via another channel) in a database 308. The database 308 is configured to store one or more of food data, recipe data, cooking instructions, appliance settings, one scan cook reviews and feedback, chat room data, and any other associated data.

The one scan cook system 306 is coupled to a one scan cook app API 310 configured to communicate with a one scan cook app 311 executing within a user device. The one scan cook app 311 can be configured as a third-party app or as a white label app. The one scan cook app 310, when executing in a user device, can utilize the image sensor of the user device to scan a food package (or recipe) 312. The scanning can include reading a barcode, a QR code, other machine-readable indicia, perform image recognition on the food product packaging, perform computer image recognition of the food product instructions, etc.

Once the food product has been scanned, the identifying information of the food product 312 can be sent to the one scan cook system 306 via the one scan cook app API 310. The one scan cook system 306 uses the information to access the database 308 and retrieve cooking data as described herein. The cooking data is then provided to the one scan cook app 311 via the one scan cook app API 310.

The one scan cook app 311 then transmits the cooking data to an appliance 314 via a wired or wireless connection (e.g., via a Wi-Fi module in the appliance 314).

In some implementations, the one scan cook app 311 can be integrated into the appliance 314 such that the food or recipe information can be scanned by the appliance directly through an imaging sensor coupled to the appliance or other suitable input technique (e.g., voice). For example, a microwave can include a camera that can perform the scanning of the food package or recipe, and the microwave can communicate directly with the one scan cook system 306 via the one scan cook app API 310.

FIG. 4 is a block diagram of an example device 400 which may be used to implement one or more features described herein. In one example, device 400 may be used to implement a client device, e.g., any of client devices 120-126 shown in FIG. 1. Alternatively, device 400 can implement a server device, e.g., server device 104, etc. In some implementations, device 400 may be used to implement a client device, a server device, or a combination of the above. Device 400 can be any suitable computer system, server, or other electronic or hardware device as described above.

One or more methods described herein (e.g., one scan cook) can be run in a standalone program that can be executed on any type of computing device, a program run on a web browser, a mobile application (“app”) run on a mobile computing device (e.g., cell phone, smart phone, tablet computer, wearable device (wristwatch, armband, jewelry, headwear, virtual reality goggles or glasses, augmented reality goggles or glasses, head mounted display, etc.), laptop computer, etc.).

In one example, a client/server architecture can be used, e.g., a mobile computing device (as a client device) sends user input data to a server device and receives from the server the final output data for output (e.g., for display). In another example, all computations can be performed within the mobile app (and/or other apps) on the mobile computing device. In another example, computations can be split between the mobile computing device and one or more server devices.

In some implementations, device 400 includes a processor 402, a memory 404, and I/O interface 406. Processor 402 can be one or more processors and/or processing circuits to execute program code and control basic operations of the device 400. A “processor” includes any suitable hardware system, mechanism or component that processes data, signals or other information. A processor may include a system with a general-purpose central processing unit (CPU) with one or more cores (e.g., in a single-core, dual-core, or multi-core configuration), multiple processing units (e.g., in a multiprocessor configuration), a graphics processing unit (GPU), a field-programmable gate array (FPGA), an application-specific integrated circuit (ASIC), a complex programmable logic device (CPLD), dedicated circuitry for achieving functionality, a special-purpose processor to implement neural network model-based processing, neural circuits, processors optimized for matrix computations (e.g., matrix multiplication), or other systems.

In some implementations, processor 402 may include one or more co-processors that implement neural-network processing. In some implementations, processor 402 may be a processor that processes data to produce probabilistic output, e.g., the output produced by processor 402 may be imprecise or may be accurate within a range from an expected output. Processing need not be limited to a particular geographic location or have temporal limitations. For example, a processor may perform its functions in “real-time,” “offline,” in a “batch mode,” etc. Portions of processing may be performed at different times and at different locations, by different (or the same) processing systems. A computer may be any processor in communication with a memory.

Memory 404 is typically provided in device 400 for access by the processor 402 and may be any suitable processor-readable storage medium, such as random-access memory (RAM), read-only memory (ROM), Electrically Erasable Read-only Memory (EEPROM), Flash memory, etc., suitable for storing instructions for execution by the processor, and located separate from processor 402 and/or integrated therewith. Memory 404 can store software operating on the server device 400 by the processor 402, including an operating system 408, machine-learning application 430, one scan cook application 412, and application data 414. Other applications may include applications such as a data display engine, web hosting engine, image display engine, notification engine, social networking engine, etc. In some implementations, the machine-learning application 430 and one scan cook application 412 can each include instructions that enable processor 402 to perform functions described herein, e.g., some or all of the methods of FIGS. 2, 3, and 5-7.

The machine-learning application 430 can include one or more NER implementations for which supervised and/or unsupervised learning can be used. The machine learning models can include multi-task learning based models, residual task bidirectional LSTM (long short-term memory) with conditional random fields, statistical NER, etc. The Device can also include a one scan cook application 412 as described herein and other applications. One or more methods disclosed herein can operate in several environments and platforms, e.g., as a stand-alone computer program that can run on any type of computing device, as a web application having web pages, as a mobile application (“app”) run on a mobile computing device, etc.

In various implementations, machine-learning application 430 may utilize Bayesian classifiers, support vector machines, neural networks, or other learning techniques. In some implementations, machine-learning application 430 may include a trained model 434, an inference engine 436, and data 432. In some implementations, data 432 may include training data, e.g., data used to generate trained model 434. For example, training data may include any type of data suitable for training a model for one scan cook tasks, such as images, labels, thresholds, etc. associated with one scan cook tasks described herein. Training data may be obtained from any source, e.g., a data repository specifically marked for training, data for which permission is provided for use as training data for machine-learning, etc. In implementations where one or more users permit use of their respective user data to train a machine-learning model, e.g., trained model 434, training data may include such user data. In implementations where users permit use of their respective user data, data 432 may include permitted data.

In some implementations, data 432 may include collected data such as appliance data, cooking data, feedback on cooking results (e.g., reviews, pictures, ratings, etc.). In some implementations, training data may include synthetic data generated for the purpose of training, such as data that is not based on user input or activity in the context that is being trained, e.g., data generated from simulated conversations, computer-generated images, etc. In some implementations, machine-learning application 430 excludes data 432. For example, in these implementations, the trained model 434 may be generated, e.g., on a different device, and be provided as part of machine-learning application 430. In various implementations, the trained model 434 may be provided as a data file that includes a model structure or form, and associated weights. Inference engine 436 may read the data file for trained model 434 and implement a neural network with node connectivity, layers, and weights based on the model structure or form specified in trained model 434.

Machine-learning application 430 also includes a trained model 434. In some implementations, the trained model 434 may include one or more model forms or structures. For example, model forms or structures can include any type of neural-network, such as a linear network, a deep neural network that implements a plurality of layers (e.g., “hidden layers” between an input layer and an output layer, with each layer being a linear network), a convolutional neural network (e.g., a network that splits or partitions input data into multiple parts or tiles, processes each tile separately using one or more neural-network layers, and aggregates the results from the processing of each tile), a sequence-to-sequence neural network (e.g., a network that takes as input sequential data, such as words in a sentence, frames in a video, etc. and produces as output a result sequence), etc.

The model form or structure may specify connectivity between various nodes and organization of nodes into layers. For example, nodes of a first layer (e.g., input layer) may receive data as input data 432 or application data 414. Such data can include, for example, cooking time, mode, temperature, e.g., when the trained model is used for one scan cook functions. Subsequent intermediate layers may receive as input output of nodes of a previous layer per the connectivity specified in the model form or structure. These layers may also be referred to as hidden layers. A final layer (e.g., output layer) produces an output of the machine-learning application. For example, the output may be a set of labels depending on the specific trained model. In some implementations, model form or structure also specifies a number and/or type of nodes in each layer.

In different implementations, the trained model 434 can include a plurality of nodes, arranged into layers per the model structure or form. In some implementations, the nodes may be computational nodes with no memory, e.g., configured to process one unit of input to produce one unit of output. Computation performed by a node may include, for example, multiplying each of a plurality of node inputs by a weight, obtaining a weighted sum, and adjusting the weighted sum with a bias or intercept value to produce the node output.

In some implementations, the computation performed by a node may also include applying a step/activation function to the adjusted weighted sum. In some implementations, the step/activation function may be a nonlinear function. In various implementations, such computation may include operations such as matrix multiplication. In some implementations, computations by the plurality of nodes may be performed in parallel, e.g., using multiple processors cores of a multicore processor, using individual processing units of a GPU, or special-purpose neural circuitry. In some implementations, nodes may include memory, e.g., may be able to store and use one or more earlier inputs in processing a subsequent input. For example, nodes with memory may include long short-term memory (LSTM) nodes. LSTM nodes may use the memory to maintain “state” that permits the node to act like a finite state machine (FSM). Models with such nodes may be useful in processing sequential data, e.g., words in a sentence or a paragraph, frames in a video, speech or other audio, etc.

In some implementations, trained model 434 may include embeddings or weights for individual nodes. For example, a model may be initiated as a plurality of nodes organized into layers as specified by the model form or structure. At initialization, a respective weight may be applied to a connection between each pair of nodes that are connected per the model form, e.g., nodes in successive layers of the neural network. For example, the respective weights may be randomly assigned, or initialized to default values. The model may then be trained, e.g., using data 432, to produce a result.

For example, training may include applying supervised learning techniques. In supervised learning, the training data can include a plurality of inputs (e.g., user appliance information, feedback and reviews from other users) and a corresponding expected output (e.g., one or more cooking instruction adjustments needed or recommended). Based on a comparison of the output of the model with the expected output, values of the weights are automatically adjusted, e.g., in a manner that increases a probability that the model produces the expected output when provided similar input. The output of the model can be used by the system to adjust cooking instructions before the cooking instructions are provided to the user device for use with an appliance.

In some implementations, training may include applying unsupervised learning techniques. In unsupervised learning, only input data may be provided, and the model may be trained to differentiate data, e.g., to cluster input data into a plurality of groups, where each group includes input data that are similar in some manner. For example, the model may be trained to identify cooking instruction adjustments that are associated with input data (e.g., appliance characteristics, etc.) and/or select thresholds for one scan cook recommendations.

In another example, a model trained using unsupervised learning may cluster words based on the use of the words in data sources. In some implementations, unsupervised learning may be used to produce knowledge representations, e.g., that may be used by machine-learning application 430. In various implementations, a trained model includes a set of weights, or embeddings, corresponding to the model structure. In implementations where data 432 is omitted, machine-learning application 430 may include trained model 434 that is based on prior training, e.g., by a developer of the machine-learning application 430, by a third-party, etc. In some implementations, trained model 434 may include a set of weights that are fixed, e.g., downloaded from a server that provides the weights.

Machine-learning application 430 also includes an inference engine 436. Inference engine 436 is configured to apply the trained model 434 to data, such as application data 414, to provide an inference. In some implementations, inference engine 436 may include software code to be executed by processor 402. In some implementations, inference engine 436 may specify circuit configuration (e.g., for a programmable processor, for a field programmable gate array (FPGA), etc.) enabling processor 402 to apply the trained model. In some implementations, inference engine 436 may include software instructions, hardware instructions, or a combination. In some implementations, inference engine 436 may offer an application programming interface (API) that can be used by operating system 408 and/or one scan cook application 412 to invoke inference engine 436, e.g., to apply trained model 434 to application data 414 to generate an inference.

Machine-learning application 430 may provide several technical advantages. For example, when trained model 434 is generated based on unsupervised learning, trained model 434 can be applied by inference engine 436 to produce knowledge representations (e.g., numeric representations) from input data, e.g., application data 414. For example, a model trained for one scan cook tasks may produce predictions and confidences for given input information about a cooking task being proposed or planned. A model trained for suggesting one scan cook adjustments to cooking instructions may produce a suggestion for one or more adjustments to cooking instructions based on input data about an appliance, user reviews, user feedback, or other information. In some implementations, such representations may be helpful to reduce processing cost (e.g., computational cost, memory usage, etc.) to generate an output (e.g., a suggestion, a prediction, a classification, etc.). In some implementations, such representations may be provided as input to a different machine-learning application that produces output from the output of inference engine 436.

In some implementations, knowledge representations generated by machine-learning application 430 may be provided to a different device that conducts further processing, e.g., over a network. In such implementations, providing the knowledge representations rather than the images may provide a technical benefit, e.g., enable faster data transmission with reduced cost. In another example, a model trained for one scan cook may produce a cooking adjustment signal for a set of input data including one or more food packages or recipes and user appliance information being processed by the model.

In some implementations, machine-learning application 430 may be implemented in an offline manner. In these implementations, trained model 434 may be generated in a first stage and provided as part of machine-learning application 430. In some implementations, machine-learning application 430 may be implemented in an online manner. For example, in such implementations, an application that invokes machine-learning application 430 (e.g., operating system 408, one or more of one scan cook application 412 or other applications) may utilize an inference produced by machine-learning application 430, e.g., provide the inference to a user, and may generate system logs (e.g., if permitted by the user, an action taken by the user based on the inference; or if utilized as input for further processing, a result of the further processing). System logs may be produced periodically, e.g., hourly, monthly, quarterly, etc. and may be used, with user permission, to update trained model 434, e.g., to update embeddings for trained model 434.

In some implementations, machine-learning application 430 may be implemented in a manner that can adapt to particular configuration of device 400 on which the machine-learning application 430 is executed. For example, machine-learning application 430 may determine a computational graph that utilizes available computational resources, e.g., processor 402. For example, if machine-learning application 430 is implemented as a distributed application on multiple devices, machine-learning application 430 may determine computations to be carried out on individual devices in a manner that optimizes computation. In another example, machine-learning application 430 may determine that processor 402 includes a GPU with a particular number of GPU cores (e.g., 1000) and implement the inference engine accordingly (e.g., as 1000 individual processes or threads).

In some implementations, machine-learning application 430 may implement an ensemble of trained models. For example, trained model 434 may include a plurality of trained models that are each applicable to same input data. In these implementations, machine-learning application 430 may choose a particular trained model, e.g., based on available computational resources, success rate with prior inferences, etc. In some implementations, machine-learning application 430 may execute inference engine 436 such that a plurality of trained models is applied. In these implementations, machine-learning application 430 may combine outputs from applying individual models, e.g., using a voting-technique that scores individual outputs from applying each trained model, or by choosing one or more particular outputs. Further, in these implementations, machine-learning application may apply a time threshold for applying individual trained models (e.g., 0.5 ms) and utilize only those individual outputs that are available within the time threshold. Outputs that are not received within the time threshold may not be utilized, e.g., discarded. For example, such approaches may be suitable when there is a time limit specified while invoking the machine-learning application, e.g., by operating system 408 or one or more other applications, e.g., one scan cook application 412.

In different implementations, machine-learning application 430 can produce different types of outputs. For example, machine-learning application 430 can provide representations or clusters (e.g., numeric representations of input data), labels (e.g., for input data that includes images, documents, etc.), phrases or sentences (e.g., descriptive of an image or video, suitable for use as a response to an input sentence, suitable for use to determine context during a conversation, etc.), images (e.g., generated by the machine-learning application in response to input), audio or video (e.g., in response an input video, machine-learning application 430 may produce an output video with a particular effect applied, e.g., rendered in a comic-book or particular artist's style, when trained model 434 is trained using training data from the comic book or particular artist, etc. In some implementations, machine-learning application 430 may produce an output based on a format specified by an invoking application, e.g., operating system 408 or one or more applications, e.g., one scan cook application 412. In some implementations, an invoking application may be another machine-learning application. For example, such configurations may be used in generative adversarial networks, where an invoking machine-learning application is trained using output from machine-learning application 430 and vice-versa.

Any of software in memory 404 can alternatively be stored on any other suitable storage location or computer-readable medium. In addition, memory 404 (and/or other connected storage device(s)) can store one or more messages, one or more taxonomies, electronic encyclopedia, dictionaries, thesauruses, knowledge bases, message data, grammars, user preferences, and/or other instructions and data used in the features described herein. Memory 404 and any other type of storage (magnetic disk, optical disk, magnetic tape, or other tangible media) can be considered “storage” or “storage devices.”

I/O interface 406 can provide functions to enable interfacing the server device 400 with other systems and devices. Interfaced devices can be included as part of the device 400 or can be separate and communicate with the device 400. For example, network communication devices, storage devices (e.g., memory and/or database 106), and input/output devices can communicate via I/O interface 406. In some implementations, the I/O interface can connect to interface devices such as input devices (keyboard, pointing device, touchscreen, microphone, camera, scanner, sensors, etc.) and/or output devices (display devices, speaker devices, printers, motors, etc.).

Some examples of interfaced devices that can connect to I/O interface 406 can include one or more display devices 420 and one or more data stores 438 (as discussed above). The display devices 420 that can be used to display content, e.g., a user interface of an output application as described herein. Display device 420 can be connected to device 400 via local connections (e.g., display bus) and/or via networked connections and can be any suitable display device. Display device 420 can include any suitable display device such as an LCD, LED, or plasma display screen, CRT, television, monitor, touchscreen, 3-D display screen, or other visual display device. For example, display device 420 can be a flat display screen provided on a mobile device, multiple display screens provided in a goggles or headset device, or a monitor screen for a computer device.

The I/O interface 406 can interface to other input and output devices. Some examples include one or more cameras which can capture images. Some implementations can provide a microphone for capturing sound (e.g., as a part of captured images, voice commands, etc.), audio speaker devices for outputting sound, or other input and output devices.

For ease of illustration, FIG. 4 shows one block for each of processor 402, memory 404, I/O interface 406, and software blocks 408, 412, and 430. These blocks may represent one or more processors or processing circuitries, operating systems, memories, I/O interfaces, applications, and/or software modules. In other implementations, device 400 may not have all of the components shown and/or may have other elements including other types of elements instead of, or in addition to, those shown herein. While some components are described as performing blocks and operations as described in some implementations herein, any suitable component or combination of components of environment 100, device 400, similar systems, or any suitable processor or processors associated with such a system, may perform the blocks and operations described.

In some implementations, logistic regression can be used for personalization (e.g., personalizing one scan cook suggestions based on a user's pattern of cooking activity). In some implementations, the prediction model can be handcrafted including hand selected one scan cook labels and thresholds. The mapping (or calibration) from ICA space to a predicted precision within the one scan cook space can be performed using a piecewise linear model.

In some implementations, the one scan cook system could include a machine-learning model (as described herein) for tuning the system (e.g., selecting one scan cook labels and corresponding thresholds) to potentially provide improved accuracy. Inputs to the machine learning model can include ICA labels, an image descriptor vector that describes appearance and includes semantic information about one scan cook. Example machine-learning model input can include labels for a simple implementation and can be augmented with descriptor vector features for a more advanced implementation. Output of the machine-learning module can include a prediction of adjustments to cooking instructions within a one scan cook database that can include one or more adjustments to cooking mode, cooking time, cooking temperature or heat setting, cooking start delay, etc. The cooking adjustment prediction can also include a prediction of no adjustment to the base cooking instructions within the one scan cook database.

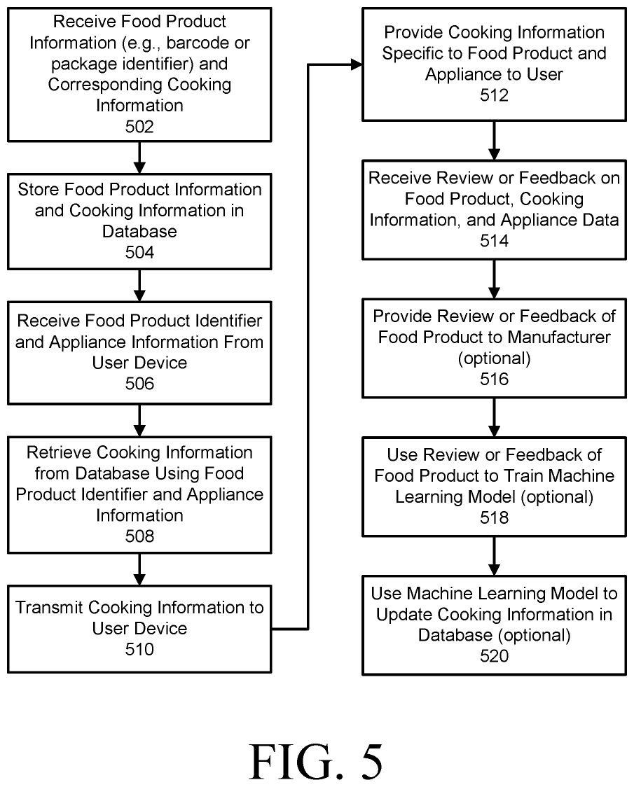

FIG. 5 is a flowchart of an example method of one scan cook in accordance with some implementations. Processing begins at 502, where food product information or recipe information is received. For example, a food product manufacturer can provide cooking data to the one cook system via a cooking data API. The cooking data can include data specific to an appliance and cooking method. For example, the cooking data can include data to cook the food product in one or more appliances such as a microwave, conventional oven, air fryer, sous vide cooking system, mixer, food processor, toaster oven or other appliance. The cooking data can include appliance type, cooking mode, cooking power setting, cooking temperature, cooking time, initial delay time (e.g., delay before cooking), intermediate delay time (e.g., delay or pause during cooking), and final delay time (e.g., delay after cooking to permit food to rest). The food product information can include step-by-step cooking data, food product nutrition data, manufacturing date/expiration date decoding information, etc. The database can also store reviews, feedback, chat room data, and other data associated with the food product, appliance, or one scan cook app users. Processing continues to 504.

At 504, food product information and cooking data is stored in the one scan cook database (e.g., 106, 308, or 414). The cooking data can be used as provided by the manufacturer or updated or modified by a machine learning model or other technique to fine tune the cooking data to help ensure good results from the one scan cook technique. Processing continues to 506.

At 506, food product (or recipe) identifier information and appliance information is received from a user device. The food product/recipe information can include one or more of a machine-readable indicium (e.g., product barcode or QR code), package appearance image recognition, a barcode or QR code associated with a recipe, a recipe itself (e.g., via optical character recognition), food cooking instructions, or other suitable machine-readable indicium. Processing continues to 508.

At 508, cooking data corresponding to the food product or recipe identifier and appliance information is retrieved from the one cook database. For example, for a mozzarella cheese stick food product and an air fryer model from a given manufacturer provided by a user one scan cook app, the corresponding cooking data is retrieved to set the air fryer for cooking the mozzarella cheese sticks. Processing continues to 510.

At 510, the cooking data is transmitted to the user device. For example, the one scan cook system can transmit the cooking data to the user device via an API (e.g., 610). Processing continues to 512.

At 512, the cooking data is provided at the user device. For example, the one scan cook application can provide information to the user including appliance settings, step-by-step cooking instructions, food product manufacturing data or expiration date, nutrition information, etc. The cooking data can be provided via display to a screen or display device, via audio output (e.g., speech), or other output method. Processing continues to 514.

At 514, the one scan cook system can receive a review or feedback on the food product, which can include the cooking data and appliance data used for the cooking. The review/feedback of the food product can include text, audio, video, or an image. Processing continues to 516.

At 516, the review/feedback of the food product can optionally be provided to the food product manufacturer. Processing continues to 518.

At 518, the review/feedback can optionally be supplied to a machine learning system to help train or adapt a machine learning model. Processing continues to 520.

At 520, an output of the machine learning model can optionally be used to update cooking data in the one scan cook database. For example, if, based on one or more reviews or feedback data, the machine learning model outputs a recommendation to adjust the cooking instruction of a particular food product and appliance combination.

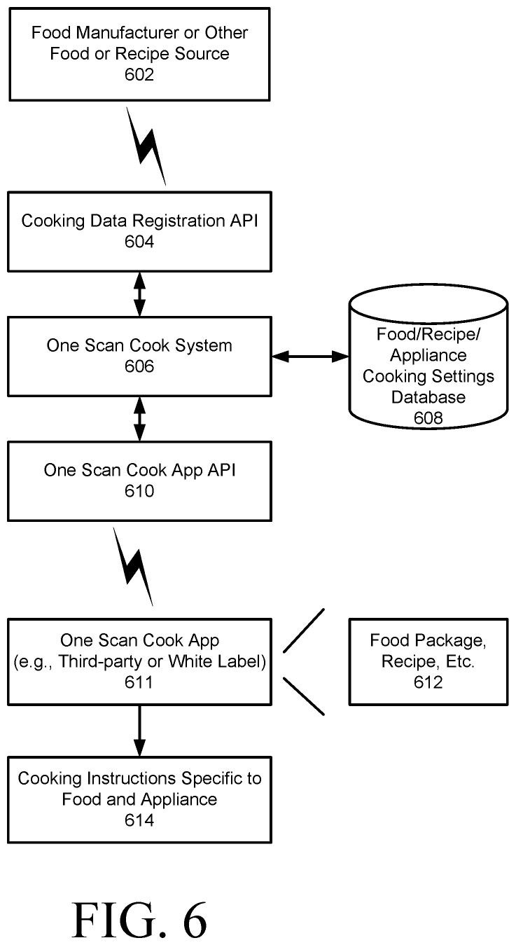

FIG. 6 is a diagram of an example one scan cook system in accordance with some implementations. FIG. 6 shows a food manufacturer or other food or recipe source 602 that can transmit food identification and/or cooking instructions via a cooking data application programming interface (API) 604 to a one scan cook system 606.

The one scan cook system 606 can store the cooking data received through the cooking data API (or via another channel) in a database 608. The database 608 is configured to store one or more of food data, recipe data, cooking instructions, appliance settings, one scan cook reviews and feedback, chat room data, and any other associated data.

The one scan cook system 606 is coupled to a one scan cook app API 610 configured to communicate with a one scan cook app 611 executing within a user device. The one scan cook app 611 can be configured as a third-party app or as a white label app. The one scan cook app 610, when executing in a user device, can utilize the image sensor of the user device to scan a food package (or recipe) 612. The scanning can include reading a barcode, a QR code, other machine-readable indicia, perform image recognition on the food product packaging, perform computer image recognition of the food product instructions, etc. In addition to scanning a food product, the one scan cook app can scan an appliance and perform image recognition to automatically determine an appliance make and model.

Once the food product and appliance has been scanned, the identifying information of the food product 612 (and appliance) can be sent to the one scan cook system 606 via the one scan cook app API 610. The one scan cook system 606 uses the information to access the database 608 and retrieve cooking data as described herein. The cooking data is then provided to the one scan cook app 611 via the one scan cook app API 610.

The one scan cook app 611 then provides the cooking data to the user (e.g., via display, audio output, or the like).

In some implementations, the one scan cook app 611 can be integrated into the appliance 614 such that the food or recipe information can be scanned by the appliance directly through an imaging sensor coupled to the appliance or other suitable input technique (e.g., voice). For example, a microwave can include a camera that can perform the scanning of the food package or recipe, and the microwave can communicate directly with the one scan cook system 606 via the one scan cook app API 610.

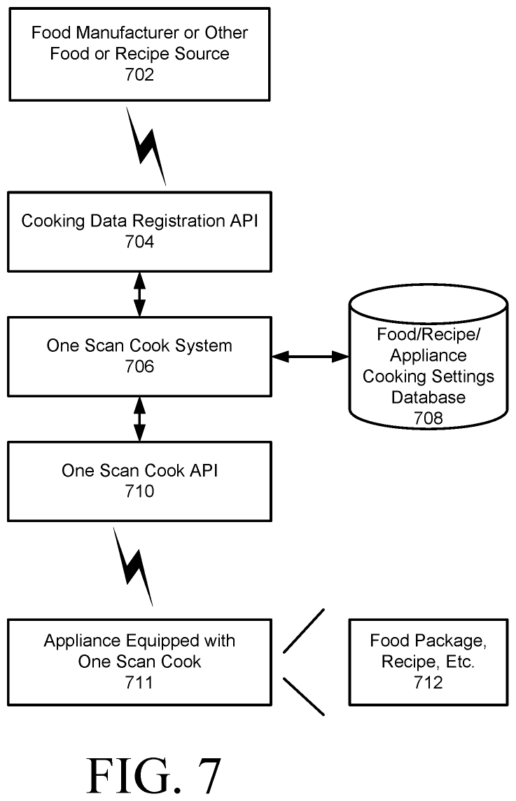

FIG. 7 is a diagram of an example one scan cook system in accordance with some implementations. FIG. 7 shows a food manufacturer or other food or recipe source 702 that can transmit food identification and/or cooking instructions via a cooking data application programming interface (API) 704 to a one scan cook system 706.

The one scan cook system 706 can store the cooking data received through the cooking data API (or via another channel) in a database 708. The database 708 is configured to store one or more of food data, recipe data, cooking instructions, appliance settings, one scan cook reviews and feedback, chat room data, and any other associated data.

The one scan cook system 706 is coupled to a one scan cook app API 710 configured to communicate with an appliance equipped with a one scan cook application 711 executing within a user device. The one scan cook app 711, when executing in the appliance, can utilize an image sensor of the appliance to scan a food package (or recipe) 712. The scanning can include reading a barcode, a QR code, other machine-readable indicia, perform image recognition on the food product packaging, perform computer image recognition of the food product instructions, etc.

Once the food product has been scanned, the identifying information of the food product 712 can be sent to the one scan cook system 706 via the one scan cook API 710. The one scan cook system 706 uses the information to access the database 708 and retrieve cooking data as described herein. The cooking data is then provided to the appliance (or appliances) equipped with one scan cook 711 via the one scan cook API 710.

As mentioned above, the one scan cook functionality can be integrated into an appliance 711 (or multiple appliances) such that the food or recipe information can be scanned by the appliance directly through an imaging sensor coupled to the appliance or other suitable input technique (e.g., voice). For example, a microwave can include a camera that can perform the scanning of the food package or recipe, and the microwave can communicate directly with the one scan cook system 706 via the one scan cook API 710. For cooking data with multiple appliances, each appliance can scan the food product and obtain the cooking instructions for that appliance to perform its part of the cooking process from the cooking data for the food product.

One or more methods described herein (e.g., the methods of FIGS. 2, 3, and 5-7) can be implemented by computer program instructions or code, which can be executed on a computer. For example, the code can be implemented by one or more digital processors (e.g., microprocessors or other processing circuitry), and can be stored on a computer program product including a non-transitory computer readable medium (e.g., storage medium), e.g., a magnetic, optical, electromagnetic, or semiconductor storage medium, including semiconductor or solid state memory, magnetic tape, a removable computer diskette, a random access memory (RAM), a read-only memory (ROM), flash memory, a rigid magnetic disk, an optical disk, a solid-state memory drive, etc. The program instructions can also be contained in, and provided as, an electronic signal, for example in the form of software as a service (SaaS) delivered from a server (e.g., a distributed system and/or a cloud computing system). Alternatively, one or more methods can be implemented in hardware (logic gates, etc.), or in a combination of hardware and software. Example hardware can be programmable processors (e.g., Field-Programmable Gate Array (FPGA), Complex Programmable Logic Device), general purpose processors, graphics processors, Application Specific Integrated Circuits (ASICs), and the like. One or more methods can be performed as part of or component of an application running on the system, or as an application or software running in conjunction with other applications and operating system.

One or more methods described herein can be run in a standalone program that can be run on any type of computing device, a program run on a web browser, a mobile application (“app”) run on a mobile computing device (e.g., cell phone, smart phone, tablet computer, wearable device (wristwatch, armband, jewelry, headwear, goggles, glasses, etc.), laptop computer, etc.). In one example, a client/server architecture can be used, e.g., a mobile computing device (as a client device) sends user input data to a server device and receives from the server the final output data for output (e.g., for display). In another example, all computations can be performed within the mobile app (and/or other apps) on the mobile computing device. In another example, computations can be split between the mobile computing device and one or more server devices.

Although the description has been described with respect to particular implementations thereof, these particular implementations are merely illustrative, and not restrictive. Concepts illustrated in the examples may be applied to other examples and implementations.

Note that the functional blocks, operations, features, methods, devices, and systems described in the present disclosure may be integrated or divided into different combinations of systems, devices, and functional blocks. Any suitable programming language and programming techniques may be used to implement the routines of particular implementations. Different programming techniques may be employed, e.g., procedural or object-oriented. The routines may execute on a single processing device or multiple processors. Although the steps, operations, or computations may be presented in a specific order, the order may be changed in different particular implementations. In some implementations, multiple steps or operations shown as sequential in this specification may be performed at the same time.

What is claimed is:

1. A computer-implemented method comprising:
receiving, at one or more processors, food product information and corresponding cooking information;
storing, using the one or more processors, the food product information and the corresponding cooking information in a data store;
receiving, at the one or more processors, food product information and appliance information from a user device;
retrieving, using the one or more processors, cooking information from the data store, wherein the cooking information corresponds to the food product information received from the user device, and wherein the cooking data can include a cooking sequence of one or more steps used to control one or more appliances; and
transmitting, using the one or more processors, the cooking information to the user device.

2. The computer-implemented method of claim 1, further comprising:
transmitting, from the user device, the cooking information to one or more appliances.

3. The computer-implemented method of claim 1, further comprising:
outputting, from the user device, the cooking information, wherein the outputting includes one or more of displaying the cooking information or providing the cooking information via audio output.

4. The computer-implemented method of claim 1, further comprising:
receiving, at the one or more processors from the user device, one or more of review information or feedback information associated with one or more of a food product, the cooking information, and appliance data.

5. The computer-implemented method of claim 4, further comprising:
providing, from the one or more processors, the review or feedback information to an external system associated with a manufacturer of the food product.

6. The computer-implemented method of claim 4, further comprising:
training, using the one or more processors, a model using the review or feedback information.

7. The computer-implemented method of claim 6, further comprising:
updating, using the one or more processors, cooking information in the data store based on output from the model trained using the review or feedback information.

8. The computer-implemented method of claim 1, wherein one or more of the food product information or the appliance information from the user device is obtained at the user device via an image sensor on the user device.

9. The computer-implemented method of claim 8, wherein the user device is a mobile device.

10. The computer-implemented method of claim 8, wherein the user device is a kitchen appliance.

11. A nontransitory computer readable medium having stored thereon software instructions that, when executed by one or more processors, causes the one or more processors to perform operations comprising:
receiving, at the one or more processors, food product information and corresponding cooking information;
storing, using the one or more processors, the food product information and the corresponding cooking information in a data store;
receiving, at the one or more processors, food product information and appliance information from a user device;
retrieving, using the one or more processors, cooking information from the data store, wherein the cooking information corresponds to the food product information received from the user device, and wherein the cooking information can include a cooking sequence of one or more steps used to control one or more appliances; and
transmitting, using the one or more processors, the cooking information to the user device.

12. The nontransitory computer readable medium of claim 11, wherein the operations further comprise:
transmitting, from the user device, the cooking information to one or more appliances.

13. The nontransitory computer readable medium of claim 11, wherein the operations further comprise:
outputting, from the user device, the cooking information, wherein the outputting includes one or more of displaying the cooking information or providing the cooking information via audio output.

14. The nontransitory computer readable medium of claim 11, wherein the operations further comprise:
receiving, at the one or more processors from the user device, one or more of review information or feedback information associated with one or more of a food product, the cooking information, and appliance data.

15. The nontransitory computer readable medium of claim 14, wherein the operations further comprise:
providing, from the one or more processors, the review or feedback information to an external system associated with a manufacturer of the food product.

16. The nontransitory computer readable medium of claim 14, wherein the operations further comprise:
training, using the one or more processors, a model using the review or feedback information.

17. The nontransitory computer readable medium of claim 16, wherein the operations further comprise:
updating, using the one or more processors, cooking information in the data store based on output from the model trained using the review or feedback information.

18. The nontransitory computer readable medium of claim 11, wherein one or more of the food product information or the appliance information from the user device is obtained at the user device via an image sensor on the user device.

19. The nontransitory computer readable medium of claim 18, wherein the user device is a mobile device.

20. The nontransitory computer readable medium of claim 18, wherein the user device is a kitchen appliance.
